(19) United States
(12) Patent Application Publication
(10) Pub. No.: US 2023/0390143 A1
(43) Pub. Date: Dec. 7, 2023

(54) SKINCARE APPARATUS AND SYSTEM

(71) Applicant: Pattern Inc., Lehi, UT (US)

(72) Inventors: Luke FROMOWITZ, Reno, NV (US); Starr WEN, Mountain View, CA (US)

(73) Assignee: Pattern Inc., Lehi, UT (US)

(21) Appl. No.: 17/832,600

(22) Filed: Jun. 4, 2022

(51) Int. Cl. A61H 9/00

(52) U.S. Cl. CPC A61H 9/0057; A61H 2201/5058; A61H 2201/0153; A61H 2201/5007; A61H 2201/10; A61H 2201/1685; A61H 2201/5043; A61H 2201/1207; A61H 2201/5025

(57) ABSTRACT

A skincare apparatus that includes a body having a coupling interface configured to couple a first accessory to the body. The skincare apparatus also includes an electronic circuit that has a sensor configured to identify the first accessory and a control circuit coupled to the sensor and configured to actuate a first operation mode associated with the identified first accessory. The skincare apparatus also includes a power supply configured to power the electronic circuit.

### TECHNICAL FIELD

The present disclosure relates to skincare apparatuses, devices, and systems. More specifically, the present disclosure relates to improved skincare apparatuses, devices, and systems that change modes automatically.

### BACKGROUND

Advancements in skincare technology enable users to perform a variety of skin treatments at home without the need to visit an office, clinic, or other venue. Conventional devices enable a user to perform skin treatments such as toning, exfoliation, and extraction.

However, conventional devices have shortcomings. For example, existing devices can be large and heavy and may be designed to remain in one location such as a user's residence and are thus not readily portable. In addition, such devices may support a variety of skin care treatments using a single device. To enable the different skin care treatments a user may need to perform two steps. First, a user may need to change an accessory connected or coupled to the skincare device. Second, the user needs to activate a switch which changes the operating mode of the skincare device from an appropriate operation mode for the accessory the user has attached to the skincare device.

However, proper operation of the skincare device can be hindered if a user does not do each step correctly. For example, a user may unknowingly connect a toning accessory to the skincare device but then activate an exfoliation operation mode. While such a mix up may not pose a physical safety risk to the user, operating one accessory in an incorrect operation mode can result in the user obtaining unsatisfactory results. Consequently, the user may blame the skincare device and/or its manufacturer. This unsatisfaction can lead to unfavorable reviews and a negative reputation for the manufacturer. Some manufacturers may try to avoid such mix ups by including instructions for the user, often in a number of different languages, with text and diagrams to assist a user in using the skincare device as designed and intended.

Accordingly, a need exists for improved skincare device, apparatus, and system that supports multiple functions or features with a single unit, which is portable, and which removes the need for a user to correctly match an accessory with an operation mode predefined for use with the accessory.

### SUMMARY

The various apparatus, devices, systems, and/or methods of the present disclosure have been developed in response to the present state of the art, and in particular, in response to the problems and needs in the art that have not yet been fully solved by currently available technology. One general aspect of the present disclosure can include a body that may include a coupling interface configured to couple a first accessory to the body and an electronic circuit that may include a sensor configured to identify the first accessory, a control circuit coupled to the sensor and configured to actuate a first operation mode associated with the identified first accessory. The apparatus includes a power supply configured to power the electronic circuit.

Implementations may include one or more of the following features. The skincare apparatus may include: a second accessory configured to couple to the body by way of the coupling interface; where the sensor is further configured to identify the second accessory, when the second accessory is coupled to the body; and where the control circuit is further configured to actuate a second operation mode associated with the identified second accessory.

The control circuit is further configured to switch modes from the first operation mode to the second operation mode. The first accessory may include a first indicator detectable by the sensor in response to the coupling interface coupling the first accessory to the body. The sensor is further configured to identify a second accessory coupled to the body by way of the coupling interface, the second accessory may include a second indicator detectable by the sensor when the second accessory couples to the body and where the control circuit is configured to actuate a second operation mode associated with the identified second accessory. The control circuit is further configured to actuate a third operation mode in response to the third accessory lacking the indicator. The first indicator and the second indicator may include a single indicator type configured to assume one of a plurality of states when coupled with an accessory. The mode indicator is configured to communicate the first operation mode. The electronic circuit may include a power switch configured to communicate a power level to the control circuit in response to activation of the power switch by a user; and where the control circuit is configured to operate the pump in response to an actuated first operation mode. The control circuit operates the pump according to a feature profile that corresponds to the actuated operation mode and where the first operation mode and a second operation mode each have different feature profiles.

One general aspect of the present disclosure can include a body; a plurality of heads configured to operatively couple to the body, a power button assembly configured to communicate a power level from a user, a set of operation mode indicators configured to communicate a current operation mode to the user, a set of power level lights configured to communicate a current power level to the user, and a controller configured to identify a first head coupled to the body and actuate a first operation mode associated with the first head.

Implementations may include one or more of the following features. The skincare apparatus may include a controller where the controller is further configured to identify a second head coupled to the body and actuate a second operation mode associated with the second head. The first head may include a first magnet having a first polarity and the second head may include a second magnet having a second polarity and where the controller is further configured identify the first head based on the first polarity and identify the second head based on the second polarity. The first magnet is positioned within the first head such that the controller detects the first polarity when the first head is coupled to the body and where the second magnet is positioned within the second head such that the controller detects the second polarity when the second head is coupled to the body. The controller is further configured to switch from the first operation mode to a second operation mode in response to the first head being replaced by a second head coupled to the body. The plurality of heads are selected from the group may include of: a toning head; an extraction head; and an exfoliation head. The body may include: a shell and an inner frame configured to couple to the shell; and where the inner frame may include: the power button assembly coupled to the controller; the set of operation mode indicators coupled to the controller; the set of power level lights coupled to the controller; the controller; a battery configured to power the controller and one or more components electrically coupled to the controller in response to the power level; a motor coupled to the battery and the controller; a suction pump coupled to the motor and configured to couple with one of the plurality of heads coupled to the body; and where the body may include a magnet sensor coupled to controller, the magnet sensor configured to identify one or more of the plurality of heads when each of the heads is coupled to the body.

One general aspect of the present disclosure can include a handheld skin treatment device that may include: a magnet sensor positioned within the handheld skin treatment device such that the magnet sensor detects a skin treatment head when the skin treatment head is operably connected to the handheld skin treatment device, an electronic circuit coupled to the magnet sensor and coupled to a control circuit configured to initiate a skin treatment procedure predefined for the skin treatment head when the skin treatment head is operably connected to the handheld skin treatment device without user input, a battery configured to power the electronic circuit. The system includes a set of skin treatment heads configured to connect to the handheld skin treatment device, each skin treatment head configured for a different skin treatment procedure.

Implementations may include one or more of the following features. The skincare system may include that aspect where each skin treatment head may include an indicator positioned near an end of the skin treatment head that contacts the handheld skin treatment device. The skincare system may include a case, the case may include: a top; and a bottom may include: handheld skin treatment device cradle configured to secure the handheld skin treatment device within the case; a plurality of posts, each configured to engage a skin treatment head of the set of skin treatment heads; a filter compartment configured to store a set of disposable filters, each filter configured to sit between an opening of each of the skin treatment heads and a suction pump of the handheld skin treatment device.

### BRIEF DESCRIPTION OF THE DRAWINGS

Exemplary embodiments of the disclosure will become more fully apparent from the following description and appended claims, taken in conjunction with the accompanying drawings. Understanding that these drawings depict only exemplary embodiments and are, therefore, not to be considered limiting of the scope of the appended claims, the exemplary embodiments of the present disclosure will be described with additional specificity and detail through use of the accompanying drawings.

FIG. 1 is a block diagram of a skincare apparatus according to one embodiment.

FIG. 2 is a block diagram of a skincare apparatus according to another embodiment.

FIG. 3A is a front view of a skincare apparatus according to one embodiment.

FIG. 3B is a front view of a skincare apparatus with a plurality of accessories according to one embodiment.

FIG. 4A is a front view of a skincare apparatus according to one embodiment.

FIG. 4B is a rear view of the skincare apparatus of FIG. 4A according to one embodiment.

FIG. 4C is a top view of the skincare apparatus of FIG. 4A according to one embodiment.

FIG. 4D is a bottom view of the skincare apparatus of FIG. 4A according to one embodiment.

FIG. 4E is a right side view of the skincare apparatus of FIG. 4A according to one embodiment.

FIG. 4F is a left side view of the skincare apparatus of FIG. 4A according to one embodiment.

FIG. 5A is a front perspective view of a skincare apparatus at least partially disassembled according to one embodiment.

FIG. 5B is a rear perspective view of the skincare apparatus of FIG. 5A at least partially disassembled according to one embodiment.

FIG. 5C is a front view of the skincare apparatus of FIG. 5A at least partially disassembled according to one embodiment.

FIG. 5D is a front view of the skincare apparatus of FIG. 5A at least partially disassembled according to one embodiment.

FIGS. 6A-6F are a front perspective view, a rear perspective view, top view, bottom view, first side view, and second side view respectively, of an exemplary accessory for a skincare apparatus according to one embodiment.

FIGS. 7A-7F are a front perspective view, a rear perspective view, top view, bottom view, first side view, and second side view respectively, of an exemplary accessory for a skincare apparatus according to one embodiment.

FIGS. 8A-8F are a front perspective view, a rear perspective view, top view, bottom view, first side view, and second side view respectively, of an exemplary accessory for a skincare apparatus according to one embodiment.

FIGS. 9A-9C are perspective bottom views of an exemplary accessory and a sensor for a skincare apparatus according to one embodiment.

FIG. 10A is a perspective front view of a case top for a skincare apparatus according to one embodiment.

FIG. 10B is a perspective front view of a case bottom for a skincare apparatus according to one embodiment.

FIG. 10C is a perspective rear view of a case top for a skincare apparatus according to one embodiment.

FIG. 10D is a perspective rear view of a case bottom for a skincare apparatus according to one embodiment.

It is to be understood that the drawings are for purposes of illustrating the concepts of the disclosure and may or may not be drawn to scale. Furthermore, the drawings illustrate exemplary embodiments and do not represent limitations to the scope of the present disclosure.

### DETAILED DESCRIPTION

Exemplary embodiments of the present disclosure will be best understood by reference to the drawings, wherein like parts are designated by like numerals throughout. It will be readily understood that the components of the present disclosure, as generally described and illustrated in the Figures herein, could be arranged and designed in a wide variety of different configurations. Thus, the following more detailed description of the embodiments of the apparatus and method, as represented in the Figures, is not intended to limit the scope of the present disclosure, as claimed in this or any other application claiming priority to this application but is merely representative of exemplary embodiments of the present disclosure.

As used herein, “attribute” refers to any property, trait, aspect, quality, data value, setting, or feature of an object or thing. The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together. The phrase “fluid communication” refers to two features that are connected such that a fluid within one feature is able to pass into the other feature.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

The health and beauty industry includes a variety of products available to help consumers in caring for their skin. In addition to ointments, creams, sprays, and the like, skincare apparatus, devices, and systems have been developed for consumers. In this industry, consumers seek products that provide results and that are relatively easy, straightforward, or even intuitive to use. The present disclosure provides a skincare apparatus, device, and/or system that provides more ease of use and convenience for the user. In addition, the skincare apparatus, device, and/or system provides a single device that can perform a plurality of skin treatment procedures. The different functionality is made possible using a plurality of accessories. Advantageously, the skincare apparatus, device, and/or system provides multiple features and/or functions by way of the accessories with little or no risk that the user will misuse the device by using one accessory with an unintended operation mode.

“Skin treatment procedure” or “skincare procedure” refers to any process, method, procedure, or set of steps designed to provide one or more of therapeutic, restorative, remedial, curative, ameliorative, and/or reparative effects to at least part of skin of a person or animal. “Accessory” refers to an apparatus, device, component, system, assembly, mechanism, hardware, software, firmware, circuit, and/or module structured, organized, configured, programmed, designed, arranged, or engineered to provide one or more additional features, functions, attributes, or aspects to another apparatus, device, component, system, assembly, mechanism, hardware, software, firmware, circuit, and/or module which may be considered a primary apparatus or device and the accessory may be considered a secondary apparatus or device.

As used herein, “feature” refers to a distinctive attribute or aspect of something. (Search “feature” on google.com. Oxford Languages, 2021. Web. 20 Apr. 2021.) In certain embodiments, a feature may refer to a set of functions, actions, activities or aspects of a certain module, apparatus, device, and/or system. A feature may include one or more modifiers that identify one or more particular functions, attributes, advantages, or operations and/or particular structures relating to the feature. Examples of such modifiers applied to a feature, include, but are not limited to, “attachment feature,” “securing feature,” “alignment feature,” “adjustment feature,” “guide feature,” “protruding feature,” “engagement feature,” “fixation feature”, “disengagement feature,” “guide feature”, and the like.

“Mode” or “Operation mode” refers to a state of operation for a circuit, sub-circuit, circuitry, electronic component, hardware, software, firmware, module, logic, device, button, lever, or apparatus. When a mode is activated the circuit, sub-circuit, circuitry, electronic component, hardware, software, firmware, module, logic, device, or apparatus may perform a set of functions that are different from when the mode is not activated. In certain embodiments, a mode may be represented by one or more states in a state machine. Often “mode” is used with a modifier describing and differentiating one mode or operating state from another, for example an “operating mode” or “operation mode” relates to a mode of operation, a “calibration mode” relates to a mode of calibrating, a “distance mode” relates to distance operations, an “orientation mode” relates to navigational operations, and an “angle mode” relates to angles.

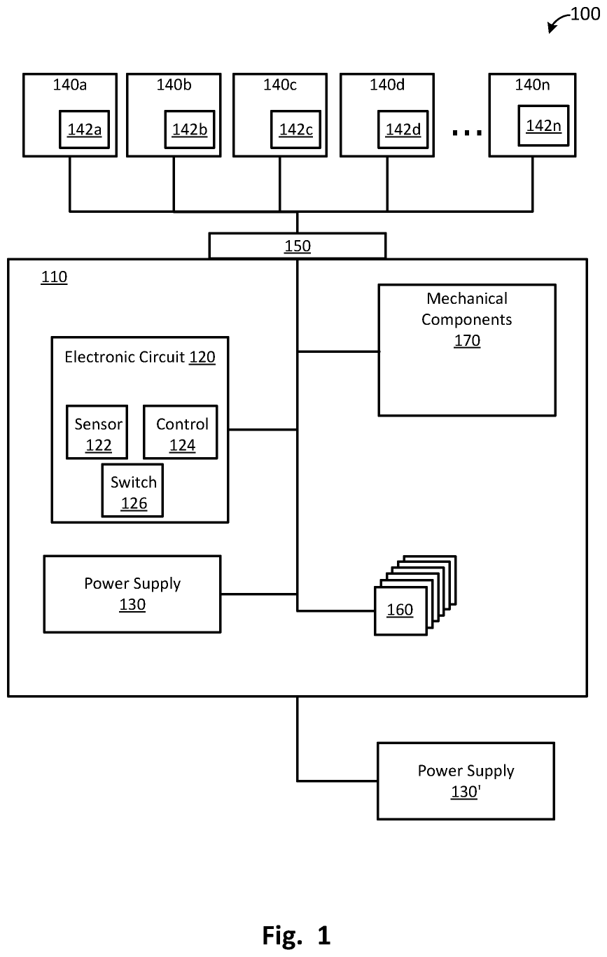

FIG. 1 is a block diagram of a skincare apparatus 100 according to one embodiment. The skincare apparatus 100 includes a body 110, an electronic circuit 120, and a power supply 130. As used herein, a “body” refers to a main or central part of a structure. The body may serve as a structural component to connect, interconnect, surround, enclose, and/or protect one or more other structural components. A body may be made from a variety of materials including, but not limited to, metal, plastic, ceramic, wood, fiberglass, acrylic, carbon, biocompatible materials, biodegradable materials or the like. A body may be formed of any biocompatible materials, including but not limited to biocompatible metals such as Titanium, Titanium alloys, stainless steel alloys, cobalt-chromium steel alloys, nickel-titanium alloys, shape memory alloys such as Nitinol, biocompatible ceramics, and biocompatible polymers such as Polyether ether ketone (PEEK) or a polylactide polymer (e.g. PLLA) and/or others. In one embodiment, a body may include a housing or frame or framework for a larger system, component, structure, or device. A body may include a modifier that identifies a particular function, location, orientation, operation, and/or a particular structure relating to the body. Examples of such modifiers applied to a body, include, but are not limited to, “inferior body,” “superior body,” “lateral body,” “medial body,” and the like.

“Electronic Circuit” or “Circuitry” refers to any circuit, sub-circuit, electronic component, hardware, module, logic, device, or apparatus configured, programmed, designed, arranged, or engineered to perform one or more features, functions, steps, methods, processes of portions thereof. In certain embodiments, an electronic circuit or circuitry may include electrical circuitry having at least one discrete electrical circuit, electrical circuitry having at least one integrated circuit, electrical circuitry having at least one application specific integrated circuit, circuitry forming a state machine, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), circuitry forming a communications device (e.g., a modem, communications switch, or optical-electrical equipment), or the like. An electronic circuit or circuitry may include one or more modifiers that identify one or more particular functions, features, aspects, attributes, advantages, roles, purposes, modes of operation, or operations and/or particular structures relating to the an electronic circuit, circuit, or circuitry. Examples of such modifiers applied to a circuit or circuitry, include, but are not limited to, “control circuit,” “test circuit,” “calibration circuit,” “sensing circuit,” “output circuit,” “input circuit,” “I/O circuit,” “measurement circuit,” “display circuit,” and the like. “Power supply” refers to an electronic system, component, assembly, apparatus, or device configured to provide electrical power in the form of current to one or more devices, components, assemblies, and/or electronic circuits. Examples of a power supply include a battery, a wall power outlet socket, a power generator, a wind turbine, a hydro-electric generator, a bank of solar cells, and the like.

The skincare apparatus 100 can assist a user in performing a plurality of skincare operations on the skin of the user or another person. Advantageously, rather than having a dedicated device for each of a variety of skincare procedures or operations a user can perform the different skincare procedures by simply changing an accessory 140 coupled or connected to the skincare apparatus 100. Advantageously, the accessory couples to the skincare apparatus 100 by way of a coupling interface 150. The body 110 may include a coupling interface 150.

As used herein, an “interface,” “user interface,” or “engagement interface” refers to an area, a boundary, or a place at which two separate and/or independent structures, members, apparatus, assemblies, components, and/or systems join, connect, are coupled, or meet and act on, or communicate, mechanically and/or electronically, with each other. In certain embodiments, “interface” may refer to a surface forming a common boundary of two bodies, spaces, structures, members, apparatus, assemblies, components, or phases. (search “interface” on Merriam-Webster.com. Merriam-Webster, 2021. Web. 15 Nov. 2021. Modified.) In certain embodiments, the term interface may be used with an adjective that identifies a type or function for the interface. For example, an engagement or coupling interface may refer to one or more structures that interact, connect, or couple to mechanically join or connect two separate structures, each connected to a side of the interface. In another example, a user interface may refer to one or more mechanical, electrical, or electromechanical structures that interact with or enable a user to provide user input, instructions, input signals, data, or data values and receive output, output data, or feedback.

The coupling interface 150 operatively couples or connects an accessory 140 to the body 110 such that the accessory 140 can be used for a skincare procedure or one or more steps within a skincare procedures. Those of skill in the art will appreciate that a variety of different coupling interfaces 150 can be used with the skincare apparatus 100. In one embodiment, the coupling interface 150 is a mechanical connection between the body 110 and one or more parts of the skincare apparatus 100 and the accessory 140. In another embodiment, the coupling interface 150 can include a mechanical connection, an electrical connection, an electromechanical connection, and/or another direct or indirect coupling between the body 110 and/or one or more parts of the skincare apparatus 100 and the accessory 140. At least one example embodiment of a coupling interface 150 will be described herein.

FIG. 1 illustrates that the skincare apparatus 100 may include a plurality of accessories 140a-n. The coupling interface 150 is configured to operatively couple or connect each of the plurality of accessories 140a-n to the body 110. One challenge the industry has faced, is how to correlate an accessory 140 coupled to the body 110 with a skincare procedure designed to may use of the coupled accessory 140. The present disclosure overcomes this challenge. In certain embodiments, the challenge is overcome using the electronic circuit 120.

The electronic circuit 120 serves to control and/or manage one or more skincare procedures performed by the skincare apparatus 100. The electronic circuit 120 can include a sensor 122, a control circuit 124, and a switch 126.

As used herein, a “sensor” refers to a device, component, circuit, system, chip, hardware, logic, or circuitry configured to detect, sense, and/or measure an attribute, feature, or characteristic of an environment, a space, a thing, an apparatus, a circuit, a component, and/or the like. Examples of a sensor include but are not limited to a speedometer, an accelerometer, a goniometer, a digital goniometer, a tiltmeter, an inclinometer, a potentiometer, a geomagnetic sensor, an acoustic sensor, a dynamic acceleration sensor, a dynamic acceleration sensor, a gyroscope, a temperature sensor, global positioning system, and the like. In certain embodiments, a single sensor may detect, sense, and/or measure a single attribute, feature, or characteristic. In other embodiments, a single sensor may detect, sense, and/or measure a plurality of attributes, features, and/or characteristics. A sensor can be made up of analog, digital, electrical, mechanical, and/or electromechanical components and may function with or without an external power source. A sensor can employ a variety of technologies in order to detect, sense, and/or measure an attribute, feature, or characteristic. For example, certain sensors may use electronic signals, radio signals, electromagnetic signals, magnetic signals, light signals, sound signals, and the like. Certain sensors may include a receiver and/or a transmitter of signals or waves for performing the sensing feature. Often a sensor is configured to communicate information about a detected, sensed, and/or measured an attribute, feature, or characteristic to another electronic component or device. The information may be communicated using a wired connection or a wireless connection.

The sensor 122 is configured to identify an accessory 140. Those of skill in the art will appreciate that a variety of different types of sensors can be used. Similarly, the sensor 122 may identify the accessory 140 in a variety of different ways. In one embodiment, the sensor 122 is configured to identify an accessory 140 when the accessory 140 is coupled to the body 110 by way of the coupling interface 150.

“Control circuit” refers to a circuit, sub-circuit, circuitry, electronic component, hardware, software, firmware, module, logic, device, or apparatus configured, programmed, designed, arranged, or engineered to direct, manage, oversee, and/or control the operation of one or more other circuits or components.

The body 110 may include one or more mechanical components 170. The mechanical components 170 serve to provide the functionality for a skincare procedure. The number, type, and configuration of mechanical components 170 may vary depending on the skincare procedure enabled by the skincare apparatus 100.

In one embodiment, the control circuit 124 is coupled to the sensor 122. The control circuit 124 is configured to actuate an operation mode 160 associated with an identified accessory 140. An operation mode may be a mode that sets out the parameters for implementing a skincare procedure. These parameters may include a variety of settings including, whether or not certain mechanical components 170 are activated, a duration for activation of those components, a set of variations in the timing of activation of these components, a set of variations in the intensity of activation of these components, and the like. Those of skill in the art will appreciate that the mechanical components 170 may include a variety of components, including but not limited to, motors, pumps, lights, electronic circuits, vacuums, speakers, or the like.

The actuated operation mode 160 may be one of a plurality of operation modes 160. The identified accessory 140 may be one of a plurality of accessories 140. For example in one embodiment, the sensor 122 and control circuit 124 may cooperate to actuate a first operation mode 160 where the sensor 122 identifies a first accessory 140, such as accessory 140a. In addition, the sensor 122 and control circuit 124 may cooperate to actuate a second operation mode 160 where the sensor 122 identifies a second accessory 140, such as accessory 140b.

Advantageously, once the sensor 122 identifies an accessory 140 the control circuit 124 can automatically switch modes from a first operation mode 160 to a second operation mode 160. In one embodiment, each operation mode 160 can correlate to a specific skincare procedure. In this manner, the possibility of mixing up an operation mode with an incorrect accessory 140 is eliminated. Accordingly, the user is assured that once an accessory 140 is identified, the skincare apparatus 100 will operate using the appropriate operation mode 160 for a given skincare procedure.

In certain embodiments, the sensor 122 may identify an accessory 140 when the accessory 140 is coupled to the body 110. Thus, once a first accessory 140a is coupled to the body 110 the sensor 122 may identify the accessory 140 and the control circuit 124 may actuate a first operation mode 160. If the first accessory 140a is replaced with a second accessory 140b, the sensor 122 may then identify the second accessory 140b and signal to the control circuit 124 that a different accessory 140 is now coupled to the body 110.

The control circuit 124 may respond by switching modes from a first operation mode 160 for a first skincare procedure to a second operation mode 160 for a second skincare procedure. Thus, the control circuit 124 may switch operation modes 160 in response to connection of a second accessory 140. In another embodiment, the control circuit 124 may be configured to respond by not switching modes from a first operation mode 160 for a first skincare procedure to a second operation mode 160 for a second skincare procedure because the second skincare procedure may be differentiated from the first skincare procedure by the type of accessory that is used and the first operation mode 160 may be suitable for the second skincare procedure.

In certain embodiments, the sensor 122 may identify an accessory 140 when the accessory 140 is coupled to the body 110, by way of an indicator 142 connected to, integrated with, or otherwise associated with the accessory 140.

As used herein, an “indicator” refers to an apparatus, device, component, system, assembly, mechanism, hardware, software, firmware, circuit, module, set of data, text, number, code, symbol, a mark, or logic structured, organized, configured, programmed, designed, arranged, or engineered to convey information or indicate a state, condition, mode, context, location, or position to another apparatus, device, component, system, assembly, mechanism, hardware, software, firmware, circuit, module, and/or a user of an apparatus, device, component, system, assembly, mechanism, hardware, software, firmware, circuit, module that includes, or is associated with the indicator. The indicator can include one or more of an audible signal, a token, a presence of a signal, an absence of a signal, a tactile signal, a visual signal or indication, a visual marker, a visual icon, a visual symbol, a visual code, a visual mark, and/or the like. In certain embodiments, “indicator” can be with a an adjective describing the indicator. For example, a “mode indicator” is an indicator that identifies or indicates a mode.

FIG. 1 illustrates that each of the plurality of accessories 140a-n may each include an indicator 142a-n that uniquely identifies that accessory 140a-n. In this manner, each accessory 140 can be associated with a specific operation mode 160. In certain embodiments, the sensor 122 is configured to identify an accessory 140 when the accessory 140 is coupled to the body 110. Said another way, the indicator 142 of the accessory 140 is detectable by the sensor 122 in response to coupling interface 150 coupling the accessory 140 to the body 110. In certain embodiments, the indicator 142 and sensor 122 cooperate to determine whether an accessory 140 is connected to the body 110 and/or whether a particular accessory 140 is connected to the body 110.

In certain embodiments, the electronic circuit 120 may include a switch 126. The switch 126 serves to electrically couple the electronic circuit 120 with the power supply 130, or optionally with the power supply 130′. The switch 126 may be referred to as a power switch because is serves to enable power to be provided from the power supply 130 to the electronic circuit 120. In certain embodiments, the switch 126 can include two settings “on” or “off”. In another embodiment, the switch 126 can include a plurality of settings such as “on”, “off”, “medium”, “medium high”, “medium low”, or the like. The settings of the switch 126 may represent power levels. In one embodiment, the switch 126 is configured to communicate a power level to the control circuit in response to activation of the power switch by a user (e.g., user input).

“Switch” refers to a circuit, sub-circuit, circuitry, electronic component, hardware, software, firmware, module, logic, device, button, lever, or apparatus configured, programmed, designed, arranged, or engineered to close an electronic circuit and/or couple one electronic component or circuit with another. In one embodiment, the switch is configured to send, transfer, or communicate, a signal to another electronic component when the switch is activated (“closed”). In certain embodiments, “switch” can be with an adjective describing the kind of switch. For example, a “power switch” is a switch that turns on and off power and/or provides a predetermine power level to a device, system, subsystem, or circuit.

“Power level” refers to an amount of power in the form of current supplied by a power supply to one or more components, apparatuses, and/or devices of a system, subsystem, apparatus, and/or device. In certain embodiments, a device or system may operate at one or more power levels within a set of power levels. Furthermore in certain embodiments, a power level may include a set of power levels in which no power is one of the power levels.

“User input” refers to any signal, action, or other indication from a user that provides direction, instruction(s), and/or information a user wants to provide to a device, apparatus, member, component, system, assembly, module, subsystem, circuit. In certain embodiments, user input can include input data provided by a user or operator. In certain embodiments, a user may provide user input using an input device such as a touchscreen, a mouse, a switch, a lever or the like.

The power supply 130 serves to provide electricity to the electronic circuit 120 and/or the mechanical components 170. In one embodiment, the power supply 130 is a battery and is configured to reside within the body 110. “Battery” refers to a device, apparatus, system, and/or component organized, configured, designed, arranged, or engineered to supply power to one or more electronic components and/or circuits. In certain embodiments, a battery is sized, positioned, and configured to be portable such that the device, apparatus, system, and/or component using the battery can be readily moved to be used or while being used. Alternatively, or in addition, in another embodiment, the power supply 130 may be an external power supply 130′ such as an electric wall outlet or socket.

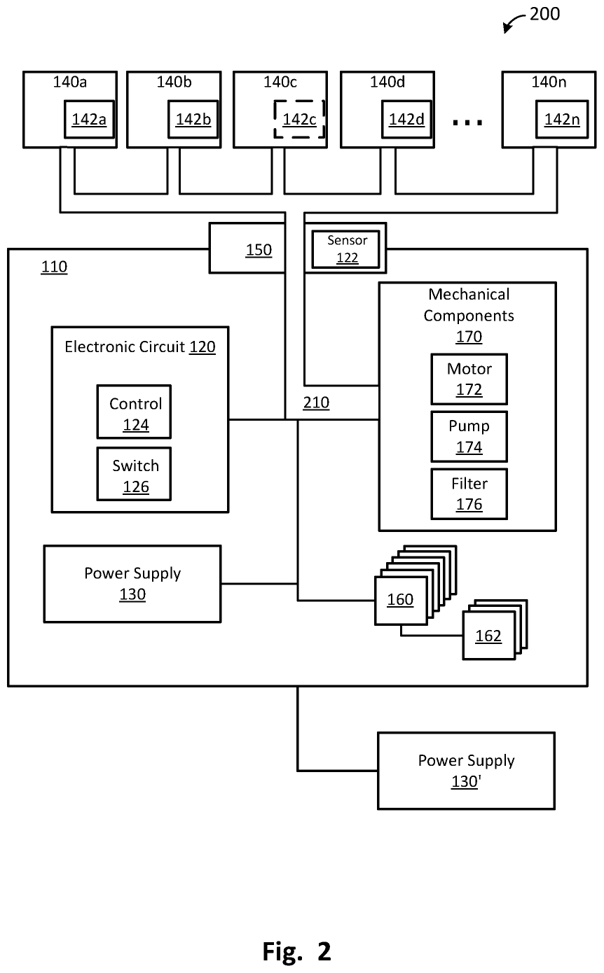

FIG. 2 is a block diagram of a skincare apparatus 200 according to another embodiment. The skincare apparatus 200 may have structures, components, features, and functions, operations, and configuration similar to that of the skincare apparatus 100 described in relation to FIG. 1. Accordingly, the skincare apparatus 200 may include a body 110, an electronic circuit 120, a power supply 130, one or more accessories 140, a coupling interface 150, one or more operation modes 160, and a set of mechanical components 170.

FIG. 2 illustrates one example of an interconnect 210 between one or more mechanical components 170 and one or more accessories 140. “Interconnect” refers to a structure configured to join at least two other structures. In one embodiment, the interconnect may be configured to convey fluid and/or an electric signal between the at least two other structures. For example, the interconnect may comprise a channel or tube configured to convey air between a first opening and a second opening in the channel or tube. Examples of an interconnect include, but are not limited to, a pipe, a tunnel, a chamber a channel, or the like.

In the illustrated embodiment, the interconnect 210 includes, incorporates, and/or may be integrated with the coupling interface 150. In this manner, the accessories 140 can be interchangeably coupled to the interconnect 210.

The mechanical components 170 may include a motor 172, a pump 174, and a filter 176. “Motor” refers to a device, apparatus, member, component, system, assembly, module, subsystem, circuit, or structure, that is organized, configured, designed, arranged, or engineered to convert energy forms into mechanical energy. (Search “motor” on wordhippo.com. WordHippo, 2022. Web. Accessed 30 Mar. 2022. Modified.) Examples of motors include, but are not limited to, electric motors, internal combustion chamber motors, and the like. “Pump” refers to a device, apparatus, member, component, system, assembly, module, subsystem, circuit, or structure, that is organized, configured, designed, arranged, or engineered to move a fluid within a conduit. The pump may move the fluid by driving the fluid through the conduit or by pulling the fluid through the conduit.

“Filter” refers to a structure, device, apparatus, member, component, system, assembly, module, or subsystem that is organized, configured, designed, arranged, or engineered to remove, trap, collect, gather, or prevent passage of one or more elements traveling in, or suspended within, a fluid. In certain embodiments, a filter may be organized, configured, designed, arranged, or engineered for use over the lifetime of a user or operator or of a system that incorporates the filter. In other embodiments, a filter may be organized, configured, designed, arranged, or engineered to provide effective service for a certain number of uses and/or amount of fluid flow past or through the filter. After these limits are met the filter may be replaced to restore effective filtration.

The motor 172 may be an electric motor configured to drive the pump 174. The pump 174 may serve to create a suction force by drawing air into the pump 174. In one embodiment, the pump 174 is in fluid communication with an accessory 140 by way of the coupling interface 150 when the coupling interface 150 couples the accessory 140 to the body 110. The motor 172 may be coupled to the pump 174 such that the pump creates a suction force at an opening of an accessory 140 coupled to the coupling interface 150. Alternatively, or in addition, the motor 172 may be coupled to the pump 174 such that the pump forces air out an opening of an accessory 140 coupled to the coupling interface 150.

The filter 176 serves to capture particles in a fluid stream, such as an airstream flowing into, or out of, the body 110. In one embodiment, the filter 176 captures and removes particles such as dirt, dust, oil, hair, makeup, and/or water from an airstream sucked into the body 110 by the pump 174. The filter 176 can help extend the life and usefulness of the pump 174 and/or motor 172. In one embodiment, the filter 176 is a permanent filter and is not replaceable. In another embodiment, the filter 176 is a temporary filter and is replaceable by a user. In yet another embodiment, the filter 176 may comprise a filter system that can include a set of filters and within the set one or more of the filters may be a temporary filter that is replaceable and one or more of the filters may be a permanent filter that is not replaceable. A permanent filter may be a filter configured to operatively function for the life of the skincare apparatus 100 and/or skincare apparatus 200.

The motor 172 and/or pump 174 may be connected to the power supply 130. In one embodiment, the motor 172 receives electricity from the power supply 130 to drive the pump 174. In certain embodiments, the control circuit 124 may manage a power level for power/electricity delivered to the motor 172. In one embodiment, the control circuit 124 is configured to operate the pump 174 based on, or in response to, an actuated operation mode 160. For example, the control circuit 124 may operate the pump 174 by controlling a power level provided to the motor 172.

In certain embodiments, one or more of the operation modes 160 can include one or more feature profiles 162. “Feature profile” refers to collection of attributes, characteristics, or aspects for a given feature, function, mode, or mode of operation for a system, subsystem, device, or apparatus. Representative examples of attributes, characteristics, or aspects of a feature may include a timing schedule, a schedule for varying performance and/or operation at certain levels (e.g. intensity levels), a set of lighting effects, a speed and/or duration for operating a motor or a pump, and the like. In one example feature profile a pump 174 may operate for x milliseconds and half power and y milliseconds at full power in order to such a desired amount of material off of a skin surface of a user.

As described above, an operation mode 160 may correspond to a particular skincare operation. Certain skincare procedures may use one or more of the same mechanical components 170 for the procedure. Accordingly, a different feature profile 162 can be used for skincare procedures and their corresponding operation modes 160 in order to adjust how mechanical components 170 are used for the skincare procedure. For example, a first feature profile 162 may include a solid steady suction force generated using the motor 172 and/or pump 174. Another feature profile 162 may include a pulsing suction force generated using the motor 172 and/or pump 174 with the pulses separated by uniform or different periods of minimal or no affirmative suction force. Still another feature profile 162 may include a different pattern of suction force followed by little or no pulse force for various time intervals.

In certain embodiments, an operation mode 160 corresponds to a single feature profile 162. In one embodiment, the control circuit 124 operates the pump 174 according to a feature profile 162 that corresponds to a first actuated operation mode 160 and wherein the first actuated operation mode 160 and a second operation mode 160 each have different feature profiles 162. Advantageously, the feature profiles 162 may be stored as data and/or instructions for operation of the control circuit 124. Thus, a manufacturer can change the feature profiles 162 after a user has purchased the skincare apparatus 100 or skincare apparatus 200 and change the operation of the operation modes 160 by way of an update to feature profiles 162 stored in the skincare apparatus 100/200.

FIG. 2 illustrates an embodiment in which the coupling interface 150 includes the sensor 122. With the sensor 122 incorporated with, or near, or close to, the coupling interface 150 the sensor 122 can detect or identify an accessory 140 when the accessory 140 is coupled to the body 110. In certain embodiments, the indicator 142 and sensor 122 cooperate to determine whether an accessory 140 is connected to the body 110 and/or whether a particular accessory 140 is connected to the body 110.

In certain embodiments, each accessory 140 may use a common type of indicator 142. For example, the indicator 142 of each accessory 140 may be a bar code, a QR code, a symbol, a color coded symbol, a mechanical keyed connection, or the like. Alternatively, or in addition, the indicator 142 can be two or more instances of a single indicator type having one of a plurality of states. “Indicator type” refers to a type of indicator. Examples of indicator types include, but are not limited to, electronic polarity, magnetic polarity, electromagnetic polarity, position, optical, sonar, magnetic, electronic, thermal, and the like.

In one embodiment, the indicator 142 is a magnet positioned in the accessory 140 with a specific polarity orientation and/or having a particular magnetic field magnitude. “Polarity” refers to an orientation of a magnetic field in a natural magnet or electromagnet. The sensor 122 can detect the indicator 142 and thereby determine which accessory 140 is coupled to the coupling interface 150. In one embodiment, the sensor 122 may be a magnetic sensor, a Hall Effect sensor, or the like.

In one embodiment, the sensor 122 is configured to identify a second accessory 140, such as accessory 140b, coupled to the body 110 by way of the coupling interface 150. The second accessory 140 comprising a second indicator 142, such as indicator 142b, detectable by the sensor 122 when the second accessory 140 couples to the body 110. In response to the sensor 122 determining that the second accessory 140 is coupled to the body 110, the control circuit 124 actuates a second operation mode 160 associated with the identified second accessory 140, such as accessory 140b. Alternatively, or in addition, in response to the sensor 122 determining that the second accessory 140 is coupled to the body 110, the control circuit 124 switches form a first operation mode 160 to a second operation mode 160 associated with the identified second accessory 140, such as accessory 140b.

In certain embodiments, two or more accessories 140 may include, or use, the same indicator 142. In such an embodiment, both accessories 140, with the same indicator 142 may be configured to operatively function with the same operation mode 160 associated with that indicator 142. While the same operation mode 160 may be used with the two or more accessories 140, the two or more accessories 140 may differ mechanically.

In one embodiment, the skincare apparatus 200 may be configured to operate using a particular operation mode 160 in response to the sensor 122 identifying that an accessory 140 lacks an indicator 142 and is thus unidentified. For example, suppose a user couples a first accessory 140 (e.g., accessory 140a) to the coupling interface 150. Accordingly, sensor 122 identifies the first accessory 140 based on the indicator 142 (e.g., indicator 142a) and the electronic circuit 120 operates the mechanical components 170 according to a first operation mode 160. Next, a user may replace the first accessory 140 (e.g., accessory 140a) with a second accessory 140 (e.g., accessory 140b). Accordingly, sensor 122 identifies the second accessory 140 based on the indicator 142 (e.g., indicator 142b) and the electronic circuit 120 operates the mechanical components 170 according to a second operation mode 160. Next, suppose a user replaces the second accessory 140 (e.g., accessory 140b) with a third accessory 140 (e.g., accessory 140c) that lacks an indicator 142. In one embodiment, the sensor 122 may not identify the third accessory 140b is coupled to the coupling interface 150 because the indicator 142 (e.g., indicator 142c) is absent. In such an embodiment, the electronic circuit 120 may be configured to operate the mechanical components 170 according to a third operation mode 160 in response to the third accessory lacking an indicator 142. In certain embodiments, the coupling interface 150 may include another switch (not shown) that is actuated when an accessory 140 is coupled to the coupling interface 150 such that the electronic circuit 120 can determine that an accessory 140 is connected even though an indicator 142 is not detected.

In one embodiment, the third operation mode 160 may be a default operation mode for use when an accessory 140 lacks an indicator 142, the indicator 142 is unidentifiable, or the like. In certain embodiments, the default operation mode may be an operation mode used with another accessory 140 that is identifiable by its indicator 142.

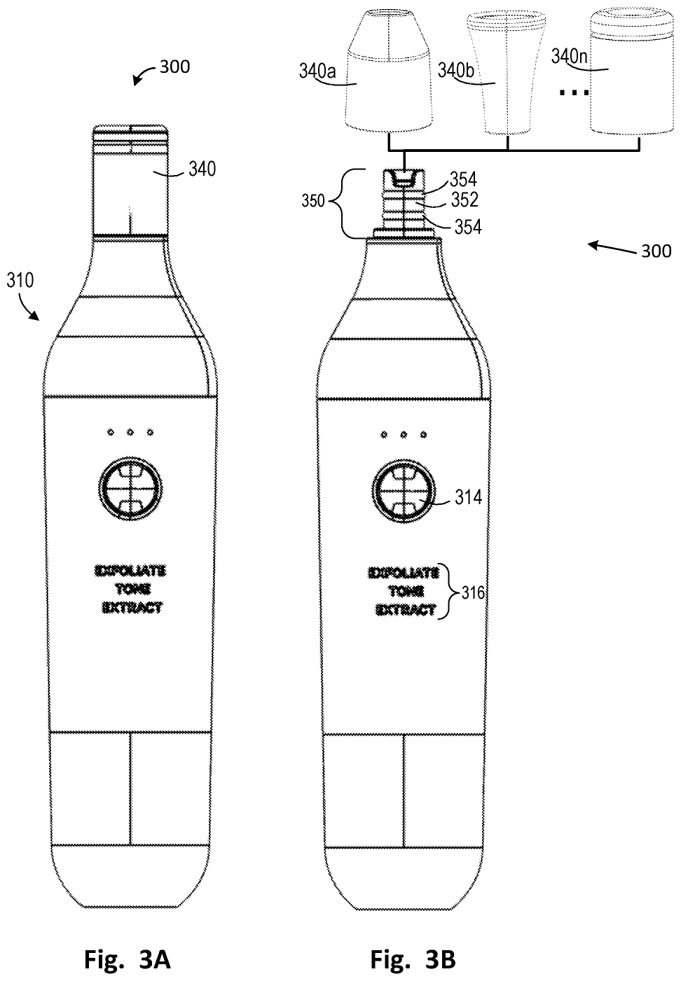

FIG. 3A is a front view of a skincare apparatus 300 according to one embodiment. The skincare apparatus 300 may have structures, components, features, and functions, operations, and configuration similar to that of the skincare apparatus 100 and/or skincare apparatus 200 described in relation to FIGS. 1 and 2, respectively.

The skincare apparatus 300 includes a body 310 similar to the body 110 described in other embodiments. The body 310 serves to house the skincare apparatus 300 and can be sized for fit comfortably in the hand of a user or operator. The skincare apparatus 300 includes a coupled accessory (referred to herein also as a head 340). In this configuration, the skincare apparatus 300 is ready for use by a user or operator. Other components described in relation to skincare apparatus 100 and/or skincare apparatus 200 are housed within the body 310.

FIG. 3B is a front view of a skincare apparatus 300 with a plurality of accessories 340 according to one embodiment. In the illustrated embodiment, the skincare apparatus 300 is upright, consequently, the accessories 340 can also be referred to as heads 340 (e.g., head 340a, head 340b, head 340n) because they sit on top of the body 310. “Head” refers to a device, apparatus, member, component, system, assembly, module, subsystem, circuit, or structure, organized, configured, designed, arranged, or engineered to have a prominent role in a particular feature, function, operation, process, method, and/or procedure for a device, apparatus, member, component, system, assembly, module, subsystem, circuit, or structure the includes, is coupled to, or interfaces with the head. In certain embodiments, the head may sit at the top or in another prominent position when interfacing with and/or coupled to a device, apparatus, member, component, system, assembly, module, subsystem, circuit, or structure. Each head 340 is configured to operatively couple to the body 310. The coupling interface 350 may enable each of the heads 340 to operatively couple to the body 310 in turn.

FIG. 3B illustrates the heads 340 disconnected from the body 310 and shows one example of a coupling interface 350 suitable for coupling each head 340 to the body 310. In one embodiment, the coupling interface 350 include a tube 352 having a circular cross section. The coupling interface 150 may also include one or more O-rings 354 coaxial with the tube 352. The O-rings 354 cooperate with internal walls of the heads 340 to form an airtight seal between the tube 352 and an opening in a head 340.

As used herein, an “opening” refers to a gap, a hole, an aperture, a port, a portal, a space or recess in a structure, a void in a structure, or the like. In certain embodiments, an opening can refer to a structure configured specifically for receiving something and/or for allowing access. In certain embodiments, an opening can pass through a structure. In other embodiments, an opening can exist within a structure but not pass through the structure. An opening can be two-dimensional or three-dimensional and can have a variety of geometric shapes and/or cross-sectional shapes, including, but not limited to a rectangle, a square, or other polygon, as well as a circle, an ellipse, an ovoid, or other circular or semi-circular shape. As used herein, the term “opening” can include one or more modifiers that define specific types of “openings” based on the purpose, function, operation, position, or location of the “opening.” As one example, a “fastener opening” refers to an “opening” adapted, configured, designed, or engineered to accept or accommodate a “fastener.”

The body 310 can include a set of power level lights 312, a power button assembly 314, and a set of operation mode indicators 316. The set of power level lights 312 communicate a current power level to a user. The current power level is a power level that the skincare apparatus 300 is currently operating at. The set of power level lights 312 can include zero, one, or more power level lights. In one embodiment, the set of power level lights 312 are LED lights electrically coupled to and controlled by a controller 320 (discussed below). Of course, the set of power level lights 312 may be any light source coupled to the controller 320. In one embodiment, the number of set of power level lights 312 illuminated may communicate the power level, the higher the number of illuminated set of power level lights 312 the higher the power level, and vice versa. If no set of power level lights 312 are lit, the power level may be zero. Alternatively, or in addition, the set of power level lights 312 may blink according to a pattern that indicates a power level to a user.

The power button assembly 314 serves as an input device that enables a user to indicate a desired power level. “Power button assembly” refers to a device, apparatus, member, component, system, assembly, module, subsystem, circuit, or structure, organized, configured, designed, arranged, or engineered to activate and/or deactivate a lower level for a device, apparatus, member, component, system, assembly, module, subsystem, circuit, or structure the includes, is coupled to, or interfaces with the power button assembly. In certain embodiments, the power button assembly may include a single unitary structure. In other embodiments, the power button assembly may include a plurality of structures and/or components that cooperate to provide the functionality of the power button assembly. For example, one or more parts of a power button assembly may engage with a body and may engage with a switch of an electrical circuit to change a power level from no power to one or more power levels in a set of power levels. The power button assembly 314 communicates a power level from a user. In certain embodiments, the power button assembly 314 communicates a desired power level from a user.

In one embodiment, the power button assembly 314 may function as an “on” and “off” switch. In another embodiment, the power button assembly 314 may function such that a user can cycle through a series of sequential power levels, such as off, low, medium, high, and fastest. Once a user changes a power level to the highest one, subsequently activating the power button assembly 314 again may cycle the power level back to “off”, or alternatively, to low, then medium, etc. In one embodiment, changing the power level to “off” may be done by pressing the power button assembly 314 and holding the power button assembly 314 in for a predetermined amount of time, such as 5 seconds.

The set of operation mode indicators 316 communicate a current operation mode to the user. The current operation mode is the operation mode the skincare apparatus 300 is currently operating in. The mode indicator 316 may communicate a current operation mode to a user in response to a signal from the controller 320.

Those of skill in the art appreciate that the set of operation mode indicators 316 can be implemented in a variety of ways. The set of operation mode indicators 316 may include a set of symbols, pictographs, text, words, audible tones, audible sounds, lights, light signals, or the like. In the illustrated embodiment, the set of operation mode indicators 316 is a set of words on a surface of the body 310. Each word may describe, or represent, a corresponding operation mode.

For example, the word “Exfoliate” may indicate to a user that the skincare apparatus 300 is operating in an Exfoliate mode. The word “Tone” may indicate to a user that the skincare apparatus 300 is operating in a Tone mode. The word “Extract” may indicate to a user that the skincare apparatus 300 is operating in an Extract mode.

In one embodiment, words that make up the set of operation mode indicators 316 may not be readily visible and the controller 320 may be configured to illuminate one of the words corresponding to a current operation mode. Illumination of the mode indicator may communicate the current operation mode by making the indicator visible. For example, when the skincare apparatus 300 is in the “Extract” mode, the controller 320 may illuminate the “Extract” word of the set of operation mode indicators 316. The controller 320 may illuminate an indicator of the set of operation mode indicators 316 using, for example, one or more LEDs. In another embodiment, words that make up the set of operation mode indicators 316 may be readily visible and the controller 320 may be configured to illuminate one of the words corresponding to a current operation mode. Illumination of the mode indicator may communicate the current operation mode by making the indicator stand out in relation to other operation mode indicators 316. In certain embodiments, the controller 320 may cause one or more set of operation mode indicators 316 to flash to indicate the current operation mode and/or a transition from one operation mode to another operation mode. For example, a prior operation mode may flash slow and a subsequent operation mode may flash faster and eventually transition to a solid, non-flashing illumination.

In another embodiment, the set of operation mode indicators 316 may be presented on an output device such as a display device. For example, text or icons or other indicators on a digital display device may be controlled and activated and/or displayed by the controller 320 to communicate to a user a current operation mode.

Advantageously, the set of operation mode indicators 316 enable a user to readily see what operation mode the skincare apparatus 300 is using. The set of power level lights 312 enable the user to readily see what power level is being used. The power button assembly 314 enables the user to readily change the power level for the skincare apparatus 300.

FIG. 3B illustrates a single body 310 that can be connected to a plurality of heads 340, such as 340a-n. Advantageously, the coupling interface 350 is configured to operatively engage with each of the heads 340. In certain embodiments, each head 340 may correspond to a different skincare procedure and/or a corresponding operation mode 160.

The skincare apparatus 300 is configured to automatically identify which head 340 is coupled with the coupling interface 350 and/or automatically actuate a particular operation mode associated with the identified head 340. Advantageously, this means that a user does not need to manually select the operation mode. In this manner, a user is not likely to mix up an accessory 140 (a head 340) and an operation mode. The user does not need to even think about what operation mode to use with each head 340. The user simply couples a head 340 to the body 310 and the skincare apparatus 300 automatically sets the appropriate operation mode.

In one embodiment, the skincare apparatus 300 includes a controller 320. The controller 320 may include the electronic circuit 120 described in relation to other embodiments. In one embodiment, the controller 320 identifies a first head, (e.g., head 340a) coupled to the body 310 and actuates a first operation mode associated with the first head, (e.g., head 340a). Advantageously, the controller 320 identifies a first head with a requirement that the first head couple to the body 310 with a particular orientation or alignment. The controller 320 is configured to identify a second head, (e.g., head 340b) coupled to the body 310 and actuate a second operation mode associated with the second head, (e.g., head 340b). No user input or action is needed, other than coupling the second head, (e.g., head 340b) to the body 310.

The controller 320 may manage all, some, or many of the operations, features, and/or functions of the skincare apparatus 300. “Controller” refers to any hardware, device, component, element, or circuit configured to manage, implement, or control the features, functions, and/or logic for a device, component, apparatus, or system, and may comprise one or more processors, programmable processors (e.g., FPGAs), ASICs, micro-controllers, electronic circuits, or the like. “Logic” refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). “Electronic Circuit” or “Circuitry” refers to any circuit, sub-circuit, electronic component, hardware, module, logic, device, or apparatus configured, programmed, designed, arranged, or engineered to perform one or more features, functions, steps, methods, processes of portions thereof. In certain embodiments, an electronic circuit or circuitry may include electrical circuitry having at least one discrete electrical circuit, electrical circuitry having at least one integrated circuit, electrical circuitry having at least one application specific integrated circuit, circuitry forming a state machine, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), circuitry forming a communications device (e.g., a modem, communications switch, or optical-electrical equipment), or the like. An electronic circuit or circuitry may include one or more modifiers that identify one or more particular functions, features, aspects, attributes, advantages, roles, purposes, modes of operation, or operations and/or particular structures relating to the an electronic circuit, circuit, or circuitry. Examples of such modifiers applied to a circuit or circuitry, include, but are not limited to, “control circuit,” “test circuit,” “calibration circuit,” “sensing circuit,” “output circuit,” “input circuit,” “I/O circuit,” “measurement circuit,” “display circuit,” and the like.

In one embodiment, the controller 320 is configured to switch from a first operation mode to a second operation mode in response to a first head (e.g., head 340a) being replaced by a second head (e.g., head 340b) coupled to the body 310. In another embodiment, the controller 320 may be configured to change operation modes once a different head 340 is detected/identified, even if the different head 340 has not yet be coupled to the body 310.

Advantageously, a variety of heads 340 can be coupled to the body 310 to support a variety of operation modes and thus a corresponding variety of skincare procedures. In one embodiment, the heads 340 can include at least an extraction head (e.g., head 340a), a toning head (e.g., head 340b), and an exfoliation head (e.g., head 340n).

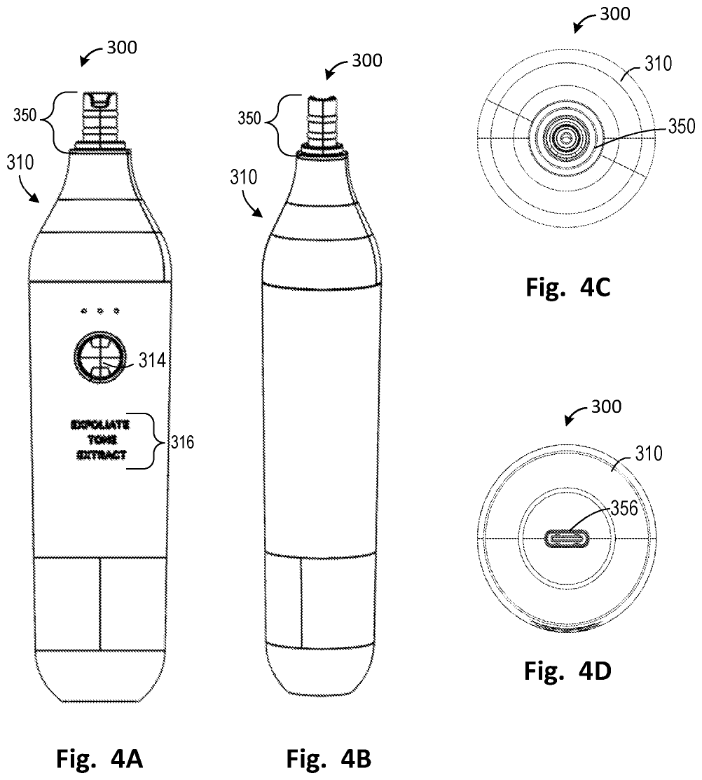

FIG. 4A is a front view of skincare apparatus 300 according to one embodiment. FIG. 4B is a rear view of the skincare apparatus of FIG. 4A according to one embodiment. FIG. 4C is a top view of the skincare apparatus of FIG. 4A according to one embodiment.

FIG. 4D is a bottom view of the skincare apparatus of FIG. 4A according to one embodiment. FIG. 4D illustrates one example of a charging connector 356. The charging connector 356 can be used by a user to recharge a power supply 130, or power supply 330, for example where the power supply 130 is a rechargeable battery. The charging connector 356 can be a conventional charging connector 356 the conforms to the standard for such connectors, such as a Universal Serial Bus (USB)-C connector. Of course, connectors that comply with other standards can be used for the charging connector 356 as well. FIG. 4E is a right side view of the skincare apparatus of FIG. 4A according to one embodiment. FIG. 4F is a left side view of the skincare apparatus of FIG. 4A according to one embodiment.

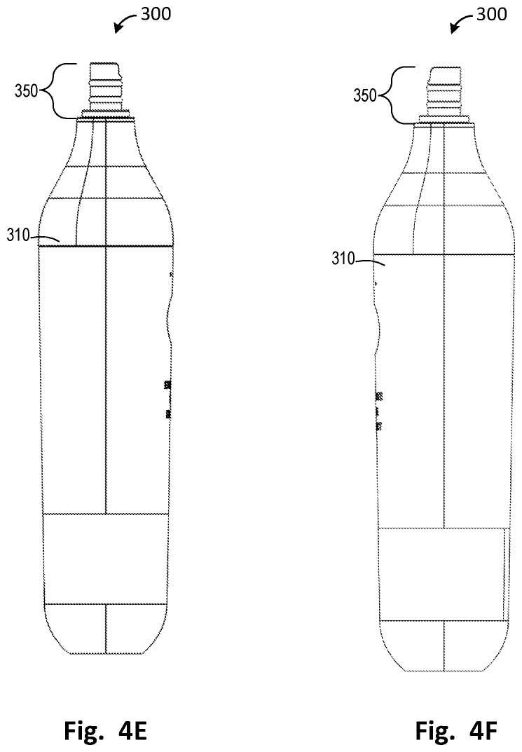

FIG. 5A is a front perspective view of a skincare apparatus at least partially disassembled according to one embodiment. In certain embodiments, the body 310 includes a shell 358 and an inner frame 360. “Shell” refers to a structure organized, configured, designed, arranged, or engineered to at least partially cover or surround another structure. In certain embodiments, the shell can be designed to protect structures within a concave part of the shell from exposure to damaging elements such as liquids.

The shell 358 serves as an external covering and/or housing for the inner frame 360. “Frame” refers to a structure organized, configured, designed, arranged, or engineered to provide structural support to one or more other devices, structure, components, and/or elements. In general a frame is rigid and provides structural support to one or more other components coupled to, integrated with, interfacing with, or connected to the frame. A frame may be a unitary component or a frame may be made up of a plurality of components. In one embodiment, the shell 358 is a hollow structure shaped, sized and configured to accept the inner frame 360 within the shell 358. The shell 358 may be made of a variety of materials including metal, plastic, composite materials, metal alloys, plastic composites, and the like. The shell 358 may be a cylindrical structure. The shell 358 can have a variety of geometric cross-sectional shapes, including, but not limited to a circle, an ellipse, an ovoid, or other circular or semi-circular shape, as well as a rectangle, a square, or other polygon.

The shell 358 can include a variety of features and/or aspects to support operation of the skincare apparatus 300. In one embodiment, the shell 358 includes one or more openings 362 configured to align with one or more power level lights 312. The shell 358 may include an opening 364 for enabling access to, and/or securement of, the power button assembly 314. The shell 358 may also include text 366 that may be used as part of one or more operation mode indicators 316. The shell 358 may include a connector 368 for connecting the shell 358 to the inner frame 360 when at least part of the inner frame 360 is positioned within the shell 358. The connector 368 can be a friction fit connector and/or a keyed connector with a corresponding structure on the inner frame 360.

The inner frame 360 provides structural support for a variety of internal components of the skincare apparatus 300. The inner frame 360 can include the power button assembly 314, a set of power level lights 312, and a set of operation mode indicators 316 each coupled to the controller 320.

FIG. 5B is a rear perspective view of the skincare apparatus 300 of FIG. 5A at least partially disassembled according to one embodiment.

FIG. 5C is a front view of the skincare apparatus 300 of FIG. 5A at least partially disassembled according to one embodiment. FIG. 5C illustrates the inner frame 360 at least partially disassembled. The inner frame 360 may include a front cover 380 configured to be connected to a base frame 390. The front cover 380 may serve as enclosure for components within the base frame 390.

The front cover 380 may include one or more openings 382 for power level lights 312 or light from the set of power level lights 312. The front cover 380 may include the power button assembly 314. The front cover 380 may include one or more openings 384 for set of operation mode indicators 316 or light from the set of operation mode indicators 316.

In one embodiment, the front cover 380 may include a sensor feature 386 configured to accept and retain a sensor 322 (e.g., sensor 122). In the illustrated embodiment, the sensor feature 386 is near the coupling interface 350. In this manner, the sensor 322 within the sensor feature 386 is close enough to a head 340 when coupled to the body 310 to accurately determine, detect, identify the head 340. In one embodiment, the sensor 322 is a magnet sensor coupled to the controller 320. The magnet sensor may be configured to identify one or more of a plurality of heads 340 (e.g., head 340a-n) when each head 340 is coupled to the body 310.

The front cover 380 may include a longitudinal axis 388 and the base frame 390 may include a longitudinal axis 389. When the front cover 380 and base frame 390 are assembled the longitudinal axis 388 aligns with and is coaxial with the longitudinal axis 389.

FIG. 5C illustrates one embodiment for an arrangement for the sensor 322 and an indicator 342 coupled to a head 340. With the front cover 380 and base frame 390 assembled the longitudinal axis 388 and longitudinal axis 389 align and the sensor feature 386 is positioned at the top of the inner frame 360. When a head 340 engages the coupling interface 350 an indicator 342 may be positioned near one end of the head 340 such that the indicator 342 is in the position indicated in FIG. 5C, just above the sensor feature 386. In such a position, the sensor 322 can readily detect the presence or absence of the indicator 342. In manner, the sensor 322 can identify a head 340 without a particular alignment of the head 340 with the coupling interface 350 or keyed structure of a coupling interface 350. In the illustrated embodiment, the indicator 342 is concentric with the coupling interface 350.

FIG. 5D is a front view of the skincare apparatus of FIG. 5A at least partially disassembled according to one embodiment. The base frame 390 may include a printed circuit board (PCB) 392 that may include the controller 320, a switch 326 (e.g., switch 126) that may interact with the power button assembly 314, and/or a set of LEDs 394,396 that may serve as the set of power level lights 312 and/or the set of operation mode indicators 316, respectively.

The base frame 390 may include a battery 402, a motor 404, and a pump 406. The battery 402 is configured to power the controller 320 and one or more components electrically coupled to the controller 320. The battery 402 may power the controller 320 and one or more components based on or in response to a power level. In one embodiment, the battery 402 is a rechargeable battery. For example, the battery 402 may be recharged using the charging connector 356.

The motor 404 is coupled to the battery 402 and the controller 320 (wire or connectors not shown). The controller 320 may operate the motor 404 to implement an operation mode. The pump 406 is coupled to the motor 404 and is configured to couple with one of the plurality of heads 340 when the head 340 is coupled to the body 310 (e.g., for example by way of the coupling interface 350). In one embodiment, the pump 406 is coupled to the motor 404 by way of tubes or pipes.

The base frame 390 may include openings 408 for accepting fasteners such as screws that can be used to connect the front cover 380 with the base frame 390. The fasteners may be rivets or screws or the like.

Referring now to FIGS. 5A-5D, with the components illustrated assembled the components cooperate to provide a skin care system, according to one embodiment. In certain embodiments, the skin care system may be similar to the example shown in FIG. 3B. Such an embodiment may include a handheld skin treatment device such as body 310 and a set of skin treatment heads 340, such as head 340a, head 340b, and/or head 340n. “Skin treatment head” refers to a head that is organized, configured, designed, arranged, or engineered to be used for a skin treatment by a user or operator.

The handheld skin treatment device may be used with and/or may include a plurality of skin treatment heads 340a-n. In one embodiment, the handheld skin treatment device includes an extraction head 340a, a toning head 340b, and an exfoliation head 340n. “Extraction head” refers to a head organized, configured, designed, arranged, or engineered to remove dirt, oil, skin, and other debris from a skin surface of a person or animal. “Toning head” refers to a head organized, configured, designed, arranged, or engineered to facilitate toning a part of the body of a person or animal. In certain embodiments, a toning head can be used to tone skin of a person or animal. “Exfoliation head” refers to a head organized, configured, designed, arranged, or engineered to exfoliate a part of the body of a person or animal. In certain embodiments, an exfoliation head can be used to exfoliate skin of a person or animal. In general, exfoliation refers to the removal of surface skin cells of a person or animal. Typically, exfoliation removes dead skin cells from the surface of the skin. Exfoliation is one example of an abrasive skin treatment that can be used for skin.

The handheld skin treatment device may include a magnet sensor (e.g., sensor 322) positioned within the handheld skin treatment device such that the magnet sensor detects a skin treatment head 340 when the skin treatment head 340 is operably connected to the handheld skin treatment device. For example, when a head 340 is coupled to the body 310 by way of the coupling interface 350, the magnet sensor may reside in a neck of the skincare apparatus 300, between the coupling interface 350 and the majority of the body 310. “Magnet sensor” refers to a sensor configured to sense one or more of a presence of a magnetic field, a magnitude of a magnetic field, and a polarity of a magnetic field. In certain embodiments, a magnet sensor can include an electronic component designed, configured, and/or engineered to serve as a magnet sensor.

The handheld skin treatment device includes an electronic circuit and a battery. The electronic circuit may be implemented using a controller 320. The electronic circuit may be coupled to the magnet sensor and coupled to a control circuit configured to initiate a skin treatment procedure predefined for a skin treatment head when the skin treatment head is operably connected to the handheld skin treatment device without user input. The skin treatment head may include an indicator positioned near an end of the skin treatment head that contacts the handheld skin treatment device. When a skin treatment head is placed on top of the body 310, the skin treatment head is in fluid communication with the pump 406 and the indicator 342 is positioned in proximity to the sensor 322.

The pump 406 may be a suction pump. “Suction pump” refers to a pump configured, designed, arranged, or engineered to suck one or more of solids, liquids, and gases from a source and store the suctioned material in a destination. In one embodiment, the pump 406 sucks in dirt, makeup, oil, dead skin cells, and the like for the skin surface of a user.

The battery may be implemented as the battery 402 illustrated. The battery 402 is configured to power the electronic circuit, which may include a controller 320. Alternatively, or in addition, the electronic circuit may be a circuit without a specific controller component. Advantageously, the handheld skin treatment device has a size, weight, design, and/or configuration that facilitate operation with the body 310 held in a user or operator's hand. The convenience of the size, weight, and ergonomics encourages continued use and performance of skincare procedure treatments.

Each skin treatment head may be configured to connect to the handheld skin treatment device, for example by way of the coupling interface 350. Each skin treatment head is configured for a different skin treatment procedure.

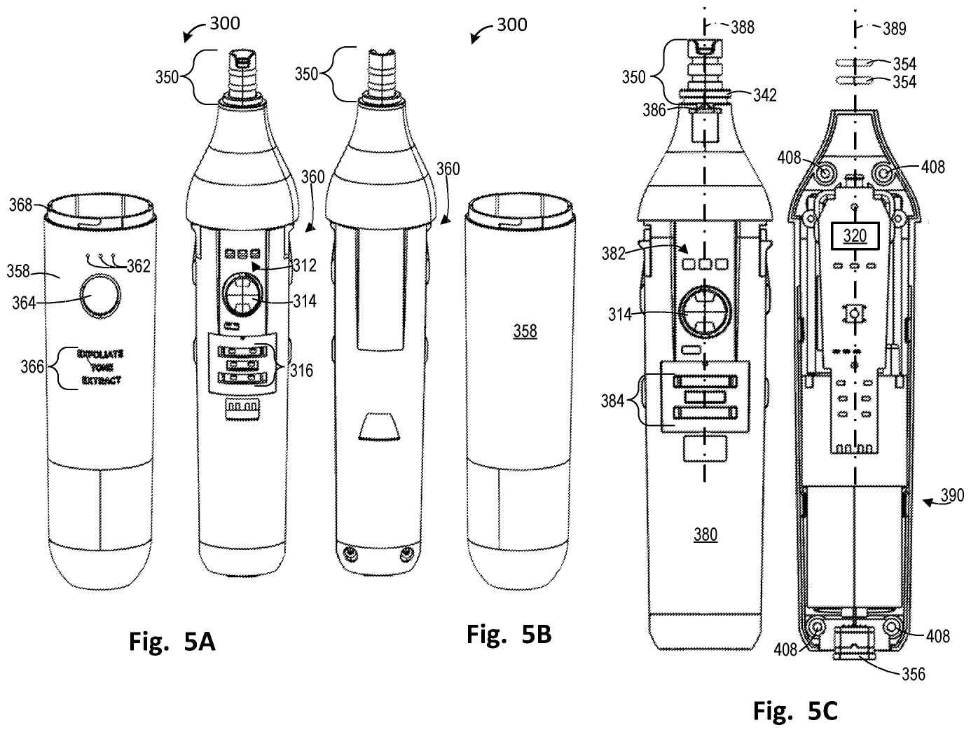

FIGS. 6A-6F are a front perspective view, a rear perspective view, top view, bottom view, first side view, and second side view respectively, of an exemplary accessory for a skincare apparatus according to one embodiment. In FIGS. 6A-6F, the exemplary accessory for a skincare apparatus is an extraction head 600. The extraction head 600 includes a top 602, a bottom 604, and an opening 608 that extends from the top 602 to the bottom 604. The opening 608 forms a channel that enables a fluid such as air to pass through the extraction head 600. FIG. 6B illustrates an embodiment of the extraction head 600 that includes a groove 610 that starts at the bottom 604 and extends into the opening 608. In one embodiment, the groove 610 is concentric with the opening 608. In one embodiment, the groove 610 is sized to accept an indicator 142. In one embodiment, the cross sectional shape of the extraction head 600 from the top 602 to the bottom 604 within the opening 608 and/or the elasticity of the walls of the extraction head 600 cooperate with the operation mode 160 of the skincare apparatus 100,200,300 to perform the skincare procedure.

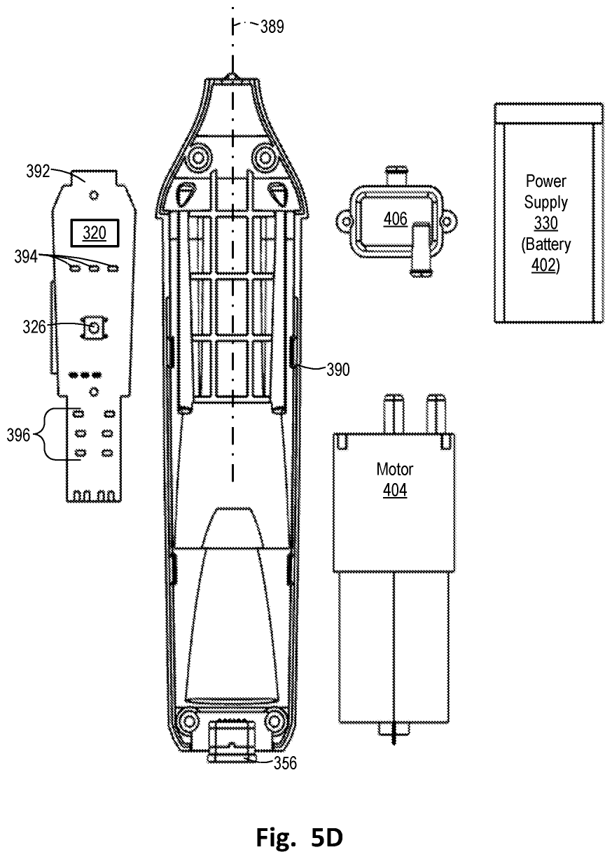

FIGS. 7A-7F are a front perspective view, a rear perspective view, top view, bottom view, first side view, and second side view respectively, of an exemplary accessory for a skincare apparatus according to one embodiment. In FIGS. 7A-7F, the exemplary accessory for a skincare apparatus is a toning head 700. The toning head 700 includes a top 702, a bottom 704, and an opening 708 that extends from the top 702 to the bottom 704. The opening 708 forms a channel that enables a fluid such as air to pass through the extraction head 700. FIG. 7B illustrates an embodiment of the toning head 700 that includes a groove 710 that starts at the bottom 704 and extends into the opening 708. In one embodiment, the groove 710 is concentric with the opening 708. In one embodiment, the groove 710 is sized to accept an indicator 142. In one embodiment, the cross sectional shape of the extraction head 700 from the top 702 to the bottom 704 within the opening 708 and/or the elasticity of the walls of the toning head 700 cooperate with the operation mode 160 of the skincare apparatus 100,200,300 to perform the skincare procedure.

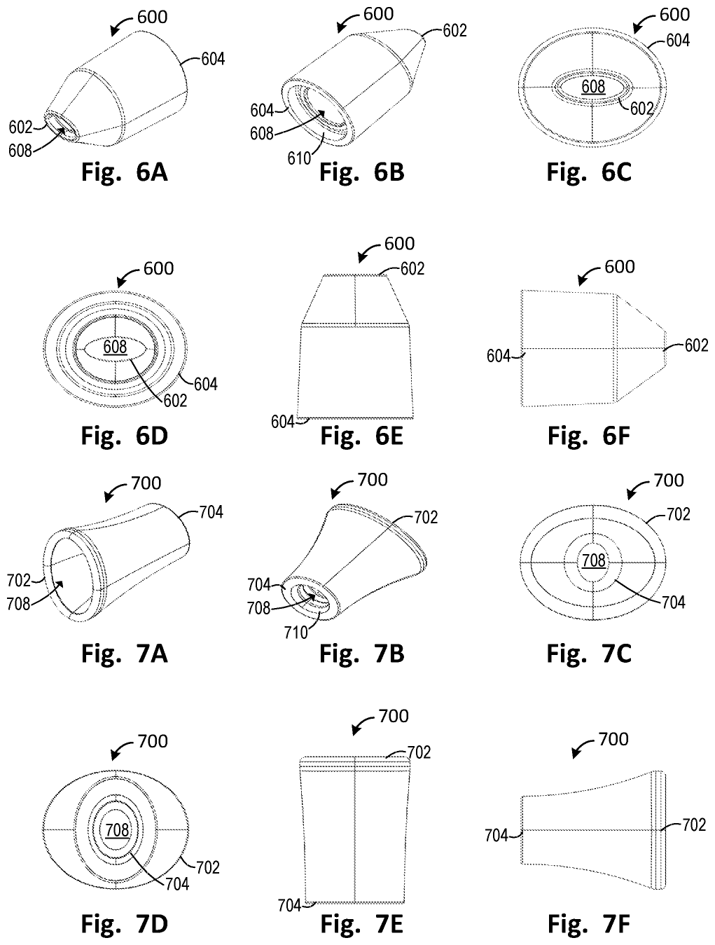

FIGS. 8A-8F are a front perspective view, a rear perspective view, top view, bottom view, first side view, and second side view respectively, of an exemplary accessory for a skincare apparatus according to one embodiment. In FIGS. 8A-8F, the exemplary accessory for a skincare apparatus is an exfoliation head 800. The exfoliation head 800 includes a top 802, a bottom 804, and an opening 808 that extends from the top 802 to the bottom 804. In certain embodiments, a surface of the top 802 may include grit (not shown) or other projections secured to and/or extending from the surface. The grit can help abrade the skin to facilitate exfoliation. The opening 808 forms a channel that enables a fluid such as air to pass through the extraction head 800. FIG. 8B illustrates an embodiment of the exfoliation head 800 that includes a groove 810 that starts at the bottom 804 and extends into the opening 808. In one embodiment, the groove 810 is concentric with the opening 808. In one embodiment, the groove 810 is sized to accept an indicator 142. In one embodiment, the cross sectional shape of the extraction head 800 from the top 802 to the bottom 804 within the opening 808 and/or the elasticity of the walls of the exfoliation head 800 cooperate with the operation mode 160 of the skincare apparatus 100,200,300 to perform the skincare procedure.

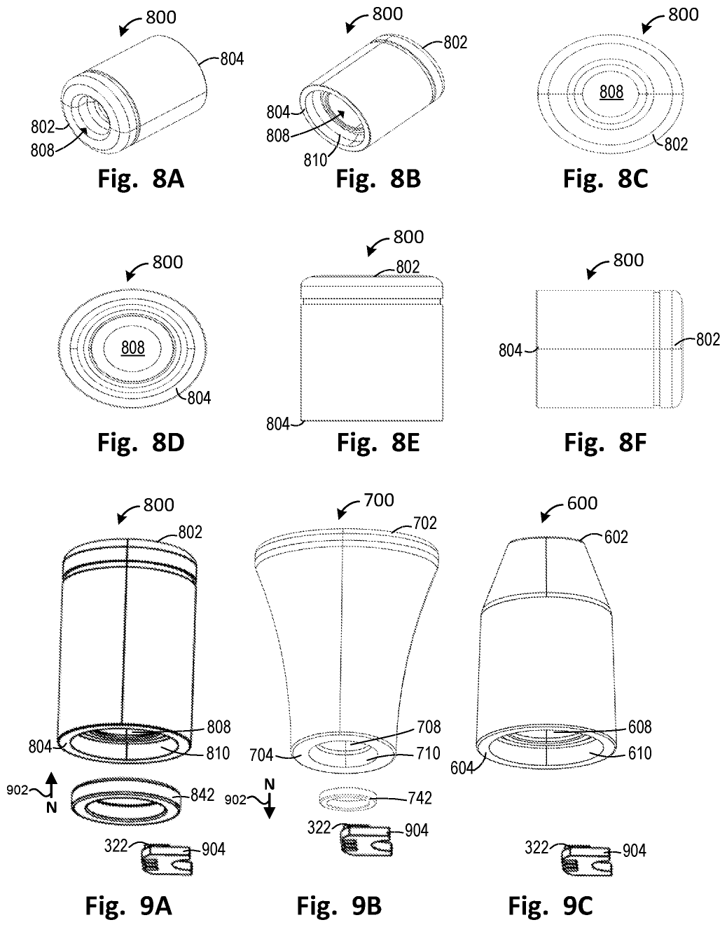

FIGS. 9A-9C are perspective bottom views of an exemplary accessory and a sensor for a skincare apparatus according to one embodiment. The exemplary accessory of FIG. 9A may be embodied as a head 340, such as exfoliation head 800 having a top 802, bottom 804, with a groove 810 at or near the bottom 804. In certain embodiments, the groove 810 has a circular cross section and a diameter greater than that of the opening 808. The groove 810 can be sized and shaped to accept a similarly sized and shaped indicator 842. In addition, the indicator 842 may include an opening that may align with the opening 808 of the exfoliation head 800.

The exemplary accessory of FIG. 9B may be embodied as a head 340, such as toning head 700 having a top 702, bottom 704, with a groove 710 at or near the bottom 704. In certain embodiments, the groove 710 has a circular cross section and a diameter greater than that of the opening 708. The groove 710 can be sized and shaped to accept a similarly sized and shaped indicator 742. In addition, the indicator 742 may include an opening that may align with the opening 708 of the toning head 700.

The exemplary accessory of FIG. 9C may be embodied as a head 340, such as extraction head 600 having a top 602, bottom 604, with a groove 610 at or near the bottom 604. In certain embodiments, the groove 610 has a circular cross section and a diameter greater than that of the opening 608. The groove 610 can be sized and shaped to accept a similarly sized and shaped indicator 342. Note, that in FIG. 9C the exemplary accessory, extraction head 600, may not have an indicator 342 installed. However, even though no indicator 342 is in the extraction head 600, the extraction head 600 is still identified and associated with an operation mode on the basis that no indicator 342 is present. The absence of an indicator 342 can be sufficient for the skincare apparatus 300 to accurately determine and actuate a suitable operation mode.

In certain embodiments, each exemplary accessory (e.g., exfoliation head 800) may include an indicator 342 that is of a specific indicator type. For example in the illustrated embodiments, FIG. 9A illustrates an exfoliation head 800 having an indicator 842, that when assembled fits within the groove 810. The indicator 842 can be secured within the groove 810 by way of an adhesive. FIG. 9B illustrates a toning head 700 having an indicator 742, that when assembled fits within the groove 710. The indicator 742 can be secured within the groove 710 by way of an adhesive. FIG. 9C illustrates an extraction head 600 having no indicator. The groove 810 may remain empty when the extraction head 600 is in use.

Each of the heads 340 (e.g., exfoliation head 800, toning head 700, and extraction head 600) may either include an indicator 342 that is of a magnetic type in which each indicator 342 includes a state that distinguishes the indicator 342 from the other indicators 342 or no indicator at all. The state for each indicator 342 (e.g., indicator 842 and/or indicator 742) may be selected from a plurality of states. In certain embodiments, the indicator 342 of each head 340 assumes one state of the plurality of states when the indicator 342 is coupled to the head 340 (i.e., accessory).

In the illustrated embodiment, the states used for the indicators 342 is magnetic polarity 902a,b. In certain embodiments, the indicator 342 comprise ring magnets having a flat top surface, a flat bottom surface, a coaxial opening having an inner diameter smaller than an outer diameter of the ring magnet. The ring magnet indicators may possess a magnetic field that is orientated parallel to a longitudinal axis of the ring magnet indicator. “Polarity” refers to an orientation of a magnetic field in a natural magnet or electromagnet. The first magnetic polarity 902a is for the north direction of the magnetic field to point up from the bottom 804 towards the top 802 of the exfoliation head 800. The second magnetic polarity 902b is for the north direction of the magnetic field to point down from the top 802 towards the bottom 804 of the exfoliation head 800.

FIGS. 9A-C illustrate an example sensor 322 that may be a magnet sensor capable of detecting the orientation of a magnetic field of a magnet in proximity to the sensor 322. The FIGS. illustrate approximately where the sensor 322 will sit with in the body 310 in accordance with one embodiment. The sensor 322 may be connected to a printed circuit board 904 and may be electrically coupled to an electronic circuit 120, control circuit 124, and/or controller 320.

FIGS. 9A-C illustrates that the exfoliation head 800 can include the indicator 842 with the magnetic polarity 902a and the toning head 700 can include the indicator 742 with the magnetic polarity 902b. The electronic circuit 120, control circuit 124, and/or controller 320 are configured to identify the exfoliation head 800 based on the magnetic polarity 902a and identify the toning head 700 based on the magnetic polarity 902b. Further the electronic circuit 120, control circuit 124, and/or controller 320 can detect that the extraction head 600 lacks an indicator 342 and thus can actuate a particular operation mode.

FIGS. 9A-C illustrate that the indicator 342 may not be detected until the head 340 is coupled to the body 310. When the head 340 is coupled to the body 310, the indicator 342 is brought within sufficient proximity to the sensor 322 positioned within the body 310 (e.g., within a neck of the body 310) that the sensor 322 can detect the magnetic polarity 902a,b or lack of magnetic polarity 902 and respond by actuating an operation mode assigned to that magnetic polarity 902a,b or lack of magnetic polarity 902. Advantageously, that bottom of the head 340 may be planar and may contact a planar surface for the coupling interface 350. When the two surfaces are in close proximity or contact that sensor can detect that the head 340 is coupled and determine an appropriate operation mode. The head 340 does not need to be rotated about the coupling interface 350 or positioned in a particular orientation about the coupling interface 350. Instead, coupling the head 340 to the coupling interface 150 is sufficient for the sensor 322 to operate and coordinate with the controller 320 and change or set the operation mode accordingly.

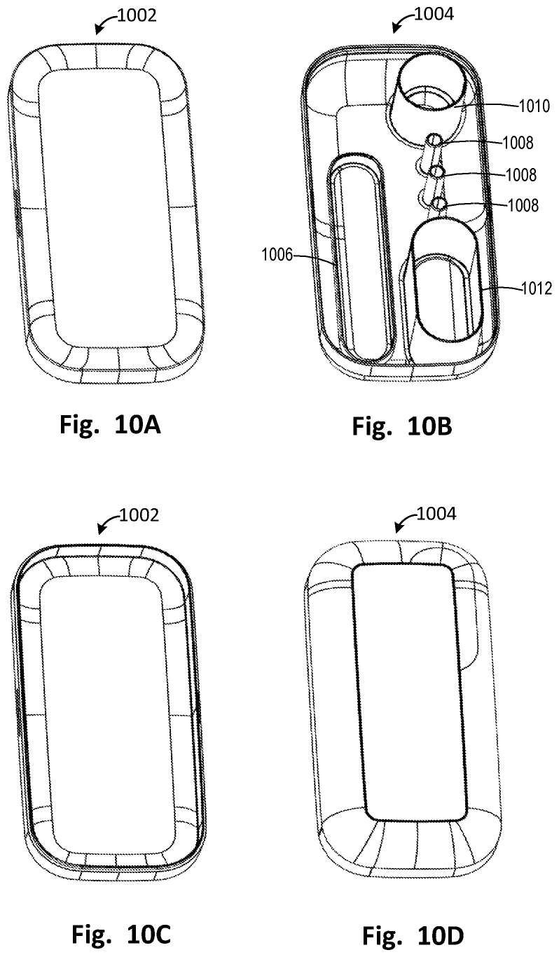

FIG. 10A is a perspective front view of a case top for a skincare apparatus according to one embodiment. FIG. 10B is a perspective front view of a case bottom for a skincare apparatus according to one embodiment. FIG. 10C is a perspective rear view of a case top for a skincare apparatus according to one embodiment. FIG. 10D is a perspective rear view of a case bottom for a skincare apparatus according to one embodiment.

Referring to FIGS. 10A-10D, in certain embodiments, handheld skin treatment device (e.g., skincare apparatus 100, skincare apparatus 200, skincare apparatus 300) may include a case. A case may be made from a variety of materials including, but not limited to, metal, plastic, ceramic, wood, fiberglass, acrylic, carbon, biocompatible materials, biodegradable materials or the like. The case may be sized to conveniently house a handheld skin treatment device, a plurality of accessories, and a variety of other materials a user may need when using the portable handheld skin treatment device.

The case can include a top 1002, and a bottom 1004. The top 1002 may serve to secure contents within the case and facilitate portability and travel with the handheld skin treatment device. The bottom 1004 can include specific compartments for components within the case. In one embodiment, the bottom 1004 may include a handheld skin treatment device cradle 1006, a plurality of posts 1008, a filter compartment 1010, and/or an additional compartment 1012. “Cradle” refers to a structure, device, apparatus, member, component, system, assembly, module, or subsystem that is organized, configured, designed, arranged, or engineered to support and/or secure one or more other components, devices, apparatuses and/or systems. In certain embodiments, a cradle may be a single unitary structure. In other embodiments, a cradle may include a plurality of parts and/or components.

The handheld skin treatment device cradle 1006 is configured to secure a handheld skin treatment device within the case. The plurality of posts 1008 are each configured to engage and secure a skin treatment head of a set of skin treatment heads. The filter compartment 1010 is configured to store a set of disposable filters, each filter configured to sit between an opening of each of the skin treatment heads and a suction pump of the handheld skin treatment device.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 Para. 6. It will be apparent to those having skill in the art that changes may be made to the details of the above-described embodiments without departing from the underlying principles set forth herein.

While specific embodiments and applications of the present disclosure have been illustrated and described, it is to be understood that the scope of this disclosure is not limited to the precise configuration and components disclosed herein. Various modifications, changes, and variations which will be apparent to those skilled in the art may be made in the arrangement, operation, and details of the methods and systems of the present disclosure set forth herein without departing from it spirit and scope.

It should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim require more features than those expressly recited in that claim. Rather, as the following claims reflect, inventive aspects can be present in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Those of skill in the art will appreciate that the solutions provided in present disclosure may be accomplished with all, or less than all, of the components, structures, features, or aspects disclosed in the specification or illustrated in the figures in relation or a particular embodiment or claim.

What is claimed is:

1. A skincare apparatus comprising:
a body comprising a coupling interface configured to couple a first accessory to the body;
an electronic circuit comprising:
a sensor configured to identify the first accessory;
a control circuit coupled to the sensor and configured to actuate a first operation mode associated with the identified first accessory; and
a power supply configured to power the electronic circuit.

2. The skincare apparatus of claim 1, comprising:
a second accessory configured to couple to the body by way of the coupling interface;
wherein the sensor is further configured to identify the second accessory, when the second accessory is coupled to the body; and
wherein the control circuit is further configured to actuate a second operation mode associated with the identified second accessory.

3. The skincare apparatus of claim 2, wherein the control circuit is further configured to switch modes from the first operation mode to the second operation mode.

4. The skincare apparatus of claim 1, wherein the first accessory comprises a first indicator detectable by the sensor in response to the coupling interface coupling the first accessory to the body.

5. The skincare apparatus of claim 4, wherein the sensor is further configured to identify a second accessory coupled to the body by way of the coupling interface, the second accessory comprising a second indicator detectable by the sensor when the second accessory couples to the body and wherein the control circuit is configured to actuate a second operation mode associated with the identified second accessory.

6. The skincare apparatus of claim 5, further comprising:
a third accessory lacking an indicator; and
wherein the control circuit is further configured to actuate a third operation mode in response to the third accessory lacking the indicator.

7. The skincare apparatus of claim 5, wherein the first indicator and the second indicator comprise a single indicator type configured to assume one of a plurality of states when coupled with an accessory.

8. The skincare apparatus of claim 1, further comprising:
a mode indicator coupled to the control circuit; and
wherein the mode indicator is configured to communicate the first operation mode.

9. The skincare apparatus of claim 1, comprising:
a pump configured in fluid communication with the first accessory by way of the coupling interface when the coupling interface couples the first accessory to the body;
a motor coupled to the pump such that the pump creates a suction force at an opening of the first accessory;
wherein the electronic circuit comprises a power switch configured to communicate a power level to the control circuit in response to activation of the power switch by a user; and
wherein the control circuit is configured to operate the pump in response to an actuated first operation mode.

10. The skincare apparatus of claim 9, wherein the control circuit operates the pump according to a feature profile that corresponds to the actuated operation mode and wherein the first operation mode and a second operation mode each have different feature profiles.

11. A skincare apparatus comprising:
a body;
a plurality of heads configured to operatively couple to the body;
a power button assembly configured to communicate a power level from a user;
a set of operation mode indicators configured to communicate a current operation mode to the user;
a set of power level lights configured to communicate a current power level to the user; and
a controller configured to identify a first head coupled to the body and actuate a first operation mode associated with the first head.

12. The skincare apparatus of claim 11, wherein the controller is further configured to identify a second head coupled to the body and actuate a second operation mode associated with the second head.

13. The skincare apparatus of claim 12, wherein the first head comprises a first magnet having a first polarity and the second head comprises a second magnet having a second polarity and wherein the controller is further configured identify the first head based on the first polarity and identify the second head based on the second polarity.

14. The skincare apparatus of claim 13, wherein the first magnet is positioned within the first head such that the controller detects the first polarity when the first head is coupled to the body and wherein the second magnet is positioned within the second head such that the controller detects the second polarity when the second head is coupled to the body.

15. The skincare apparatus of claim 11, wherein the controller is further configured to switch from the first operation mode to a second operation mode in response to the first head being replaced by a second head coupled to the body.

16. The skincare apparatus of claim 11, wherein the plurality of heads are selected from the group consisting of:
a toning head;
an extraction head; and
an exfoliation head.

17. The skincare apparatus of claim 11, wherein the body comprises:
a shell and an inner frame configured to couple to the shell; and
wherein the inner frame comprises:
the power button assembly coupled to the controller;
the set of operation mode indicators coupled to the controller;
the set of power level lights coupled to the controller;
the controller;
a battery configured to power the controller and one or more components electrically coupled to the controller in response to the power level;
a motor coupled to the battery and the controller;
a suction pump coupled to the motor and configured to couple with one of the plurality of heads coupled to the body; and
wherein the body comprises a magnet sensor coupled to controller, the magnet sensor configured to identify one or more of the plurality of heads when each of the heads is coupled to the body.

18. A skincare system comprising:
a handheld skin treatment device comprising:
a magnet sensor positioned within the handheld skin treatment device such that the magnet sensor detects a skin treatment head when the skin treatment head is operably connected to the handheld skin treatment device;
an electronic circuit coupled to the magnet sensor and coupled to a control circuit configured to initiate a skin treatment procedure predefined for the skin treatment head when the skin treatment head is operably connected to the handheld skin treatment device without user input;
a battery configured to power the electronic circuit; and
a set of skin treatment heads configured to connect to the handheld skin treatment device, each skin treatment head configured for a different skin treatment procedure.

19. The skincare system of claim 18, wherein each skin treatment head comprises an indicator positioned near an end of the skin treatment head that contacts the handheld skin treatment device.

20. The skincare system of claim 18 further comprising a case, the case comprising:
atop; and
a bottom comprising:
handheld skin treatment device cradle configured to secure the handheld skin treatment device within the case;
a plurality of posts, each configured to engage a skin treatment head of the set of skin treatment heads; and
a filter compartment configured to store a set of disposable filters, each filter configured to sit between an opening of each of the skin treatment heads and a suction pump of the handheld skin treatment device.
